(19) United States
(12) Patent Application Publication
(10) Pub. No.: US 2021/0222070 A1
(43) Pub. Date: Jul. 22, 2021

(54) LIQUID CRYSTAL MIXTURES, METHODS OF MAKING THE SAME, AND DEVICES INCLUDING THE SAME

(71) Applicant: Compound Photonics U.S. Corporation, Vancouver, WA (US)

(72) Inventor: Hemasiri Vithana, Chandler, AZ (US)

(21) Appl. No.: 17/252,324

(22) PCT Filed: Jun. 14, 2019
(86) PCT No.: PCT/US2019/037249

§ 371 Date: Dec. 15, 2020

Related U.S. Application Data
(60) Provisional application No. 62/685,854, filed on Jun. 15, 2018.
(60) Provisional application No. 62/711,408, filed on Jul. 27, 2018.

(51) Int. Cl. C09K 19/58; G02F 1/00; G02F 1/1337; C09K 19/56

(52) U.S. Cl. CPC C09K 19/586; C09K 19/56; G02F 1/133749; G02F 1/0045

(57) ABSTRACT

A liquid crystal mixture is disclosed that has a certain rotational sense when placed in a liquid crystal device and an opposite rotational sense when removed from the liquid crystal device. The liquid crystal mixture may be utilized, for example, in liquid crystal displays to achieve high contrast and to reduce potential defects and misalignments.

### FIELD OF THE INVENTION

The present invention relates to liquid crystal (LC) mixtures, methods of making the same, and devices including the same. More particularly, the present invention is directed to a LC mixture including a LC material and a chiral material, methods of making the same, and devices including the same.

### BACKGROUND OF THE INVENTION

Liquid crystal display technology has reduced the size of displays from full screen sizes to minidisplays. Microdisplays, such as liquid crystal on silicon (LCoS) displays may be manufactured using semiconductor integrated circuit (IC) technologies.

The LCoS microdisplays may include a silicon substrate backplane with a reflective surface, a cover glass and an intervening liquid crystal layer.

The LCoS microdisplays may be arranged as a matrix of pixels arranged in a plurality of rows and columns, wherein an intersection of a row and a column defines a position of a pixel in the matrix.

To incident light, each pixel is a liquid crystal cell above a reflecting mirror. By changing the molecular orientation of the liquid crystal in the layer, characterized by a tilt angle and/or a twist angle of the liquid crystal director at any point in the layer, the incident light can be made to change its polarization state.

The silicon backplane is an array of pixels, typically 3 to 20 micrometers (pm) in pitch.

Each pixel has a mirrored surface that occupies most of the pixel area. The mirrored surface is also an electrical conductor that forms a pixel capacitor with the liquid crystal display cover glass electrode. The liquid crystal display cover glass electrode is a transparent conductive coating on the inside face (liquid crystal side) of the cover glass. This transparent conductive coating is typically Indium Tin Oxide (ITO).

As each pixel capacitor is charged to a certain voltage value, the liquid crystal fluid between the plates of the pixel capacitors changes its molecular orientation which affects the polarization state of the light incident to the pixels (reflections from the pixel mirrors).

The reflective LCoS microdisplays have a high aperture ratio, and therefore can provide greater brightness than transmissive liquid crystal displays. Major applications of these LCoS microdisplays are in home theater applications, e.g., projectors, and front and rear projection televisions (large screen). For these applications, high contrast is very important.

In addition, some augmented-reality (AR), mixed-reality (MR) and virtual-reality (VR) applications use liquid-crystal-on-silicon (LCoS) displays that employ a vertically aligned nematic (VAN) optical mode because of a very dark OFF state, thereby providing a high contrast ratio.

High Contrast—VAN Mode

High contrast depends upon the liquid crystal optical mode being used in the liquid crystal display. Typically, a Vertically Aligned Nematic (VAN) mode is one of the optical modes that can achieve a very high contrast and many liquid crystal display manufacturers are beginning to use this particular optical mode in their displays.

The pretilt angle is defined as the tilt angle of the liquid crystal director at the boundary surface (surface-contacting directors). In VAN mode liquid crystal displays, the pretilt angle is small, so the orientation of the molecules of the liquid crystal fluid are nearly perpendicular to the substrate surfaces when there is no electric field applied across the display. Therefore, incoming linearly polarized light, perpendicular to the display substrates, experiences a small birefringence as it passes through the layer. Hence this normally incident linearly polarized light experiences little phase retardation when going through the liquid crystal fluid, including being reflected back from the bottom reflective substrate of the display. This provides a dark OFF” state when using crossed polarizers (e.g., polarizing beam splitter—PBS) and high contrast is achieved.

Upon application of an electric field across the liquid crystal fluid, the molecules in the bulk of the liquid crystal fluid orient themselves toward a direction defined by alignment layers on the substrate surfaces, thereby increasing the phase retardation of the layer of the liquid crystal fluid. Therefore, linearly polarized incident light starts to experience a phase retardation when going into the liquid crystal fluid and then being reflected back from the bottom reflective substrate of the display. As a result of this, the polarization state of the out-going light (reflected light) will be elliptical and some light starts to pass through the crossed polarizers. Increasing the electric field increases this effect until the brightest state is achieved.

### Alignment Layers and Pretilt Angle

In a typical VAN mode, the orientations of the molecules of the liquid crystal fluid at the substrate surfaces are defined by the alignment layers on each of the substrate surfaces. This orientation is described by a pretilt angle and a surface azimuthal direction, which is parallel to the projection of the surface-contacting liquid crystal director onto the plane of the substrate. The azimuthal direction of the molecules of the liquid crystal fluid proximate to the top alignment layer is opposite to the azimuthal direction of the molecules of the liquid crystal fluid proximate to the bottom alignment layer, i.e., anti-parallel. The azimuthal directions defined by the alignment layers are at a 45-degree angle with the direction of polarization of the incoming linearly polarized incident light.

Usually the pretilt angle of the molecules in a VAN mode display needs to be kept small, e.g., less than 4 degrees, to achieve a very dark OFF” state, hence the high contrast. Although this pretilt angle is large enough to prevent reverse tilt domains in the display, it is not possible to overcome the defects that occur due to fringe fields between neighboring pixels.

In other words, the contrast ratio may be affected by the pretilt angle of the liquid crystal. And, if the pretilt angle is too low, defects and misalignments of the liquid crystal director may occur near the inter-pixel gaps due to fringing electrical fields between adjacent pixels when they are not at the same voltage.

Such defects and misalignments may degrade the quality of the displayed images, and such defects and misalignments due to fringe fields may become pronounced for certain liquid crystal displays when the size of the pixel pitch is comparable to or smaller than the liquid crystal (LC) layer thickness (i.e., the cell gap). While the resolution achieved by an LCoS display increases as the size of the pixel pitch decreases, defects and misalignments can occur.

Attempts to increase the LC pretilt angle are commonly made to mitigate such defects and misalignments. However, increasing the pretilt angle introduces more residual retardation in the display. Such retardation may reduce the contrast ratio of a VAN-mode LCoS display.

Some attempts have been made to overcome this low contrast problem by adding a twisted structure to the VAN mode to form a twisted vertically aligned nematic (TVAN) mode, as described in U.S. Pat. Nos. 8,724,059 and 9,551,901, and such patents are hereby incorporated by reference. While this TVAN mode may increase the overall contrast ratio compared to the VAN mode, there is a demand for a higher contrast (and more grey levels) for some applications.

### BRIEF DESCRIPTION OF THE DRAWINGS

The accompanying drawings, which are included to provide a further understanding of the invention and are incorporated in and constitute a part of this specification, and together with the description serve to explain the principles of the invention.

FIG. 1 is a schematic illustration of a display including an LC mixture in accordance with the present invention.

FIG. 2 is a schematic illustration of the LC mixture in the display of FIG. 1 in accordance with the present invention.

FIG. 3 is a schematic illustration of the LC mixture of FIG. 2, where the LC mixture is isolated and independent of the display of FIG. 1 in accordance with the present invention.

FIG. 4 is a flow chart illustrating an exemplary method.

FIG. 5 is a graphical illustration of simulations of a contrast ratio vs. a d/Po ratio for a display in accordance with the present invention.

FIG. 6 is a graphical illustration of measurements of a contrast ratio vs. a d/Po ratio for a series of different displays in accordance with the present invention.

FIG. 7 is a graphical illustration of simulations of zero-voltage director tilt angle vs. distance through an LC mixture of a display for a series of d/Po ratios in accordance with the present invention.

FIG. 8 is a graphical illustration of a simulation of a director tilt angle in the middle of an LC mixture vs. d/Po of the LC mixture when no voltage is applied to a display in accordance with the present invention.

FIG. 9 is a graphical illustration of a simulation of throughput vs. d/Po when a voltage is applied to a display in accordance with the present invention.

### DETAILED DESCRIPTION OF THE ILLUSTRATED EMBODIMENTS

Reference will now be made in detail to embodiments of the present invention.

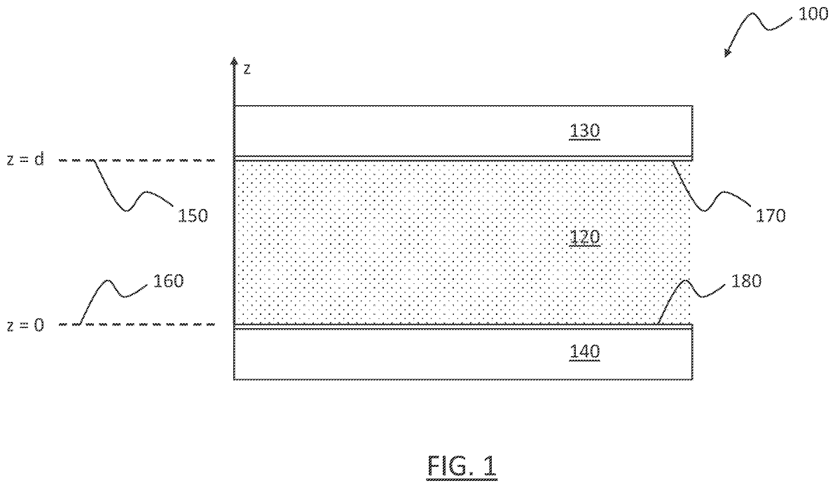

### FIG. 1—Display Structure

Referring now to FIG. 1, a portion of a liquid crystal (LC) display device 100 is schematically illustrated. The LC display device 100 may be a reflective liquid crystal on silicon (LCoS) display device or a transmissive display device. The LC display device 100 includes a plurality of pixel elements having a pixel pitch, for example, less than or equal to approximately 4.0 pm.

The display device 100 may include a glass (transparent) first substrate 130 and a reflective (mirror) second substrate 140 (i.e., reflective pixels on a substrate) that are parallel to one another and have an LC mixture 120 therebetween. The pixels could also be transmissive for an active matrix display with thin film transistors on a glass substrate.

A cell spacing or cell gap is the distance (d) between the alignment coatings 170, 180 and a thickness d of the LC mixture 120. The alignment coatings 170, 180 define boundary planes 150, 160 at z=0 and z=d that are normal to a z-axis. For example, the LC mixture 120 layer may have a thickness d in a range of 0.5 um to 3 um for a reflective display and up to 6 um for a transmissive display.

Various coatings (not shown) may be deposited on the substrates 130, 140. The glass first substrate 130 includes a transparent electrode coating (not shown) and the alignment coating 170 in contact with the LC mixture 120. The second substrate 140 includes the LC alignment coating 180 in contact with the LC mixture 120. The electrode coating, for example, is Indium Tin Oxide (ITO) and the alignment coating, for example, may be rubbed polyimide or obliquely deposited SiO₂.

As used herein, a liquid crystal material refers to a single chemical compound or combination of chemical compounds that constitute a nematic liquid crystal. The liquid crystal material has no intrinsic, built in twist.

As used herein, a chiral material refers to a chemical compound or combination of chemical compounds whose molecular structures are non-superimposable with their mirror images. Adding chiral material to a liquid crystal material induces a built-in intrinsic twist to the director field in the isolated mixture that can have either a right- or left-handed rotational sense. The isolated mixture means that it is isolated from external forces acting on the director field such as electric or magnetic fields or boundary aligning forces.

As used herein, a liquid crystal mixture refers to a mixture of at least a liquid crystal material and chiral material that has an intrinsic, built-in twist. This could also be called a chiral nematic liquid crystal mixture.

The LC mixture 120 has a negative dielectric anisotrophy.

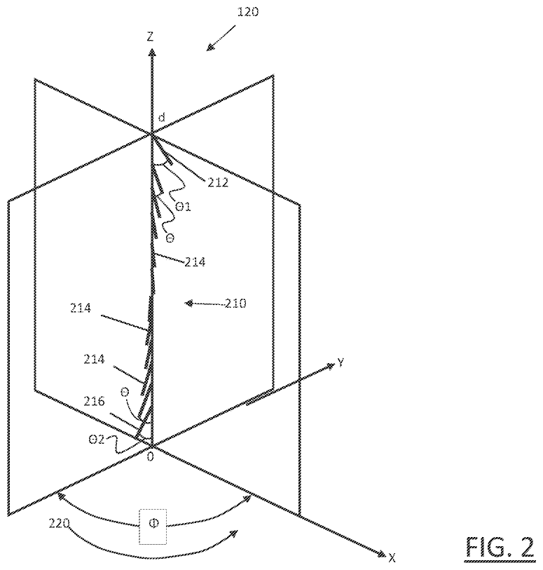

### FIG. 2: Pretilt Angle, Structural Twist Angle, and Rotational Sense of LC Mixture in Display

Referring to FIG. 2, a twisted LC structure of the LC mixture 120 is schematically illustrated. The twisted LC structure includes a director field 210. The director field 210 includes directors 212, 214, 216 that are confined between the alignment coatings 170, 180. Directors 214 are in the bulk of the LC mixture 120 layer (e.g., spaced apart from the alignment coatings 170, 180) and directors 212, 216 are surface-contacting directors (e.g., at the boundary planes 150, 160).

For example, referring to FIGS. 1 and 2, the transparent first substrate plate 130 includes a transparent conducting electrode coating (not shown) and the first liquid crystal alignment coating 170 that generates a first pretilt angle 01 and a first azimuthal direction (positive x-axis in FIG. 2) of the surface-contacting liquid crystal directors (represented in the illustrated field by surface-contacting director 212). The second substrate 140 includes a pixelated reflective coating (e.g., a backplane)(not shown) and the second liquid crystal alignment coating 180 that generates a second pretilt angle 02 and a second azimuthal direction (negative y-axis in FIG. 2) of the surface-contacting liquid crystal directors (represented in the illustrated field by surface-contacting director 216).

In the example of FIG. 2, the surface-contacting director 212 on the first alignment coating 170 lies in the x-z plane and the surface contacting director 216 on the second alignment coating 180 lies in the y-z plane.

### Pretilt Angle

The pretilt angles 01, 02 of the surface-contacting directors 212, 216 are respectively defined as the polar angle between the surface contacting directors 212, 216 at the alignment coatings 170, 180 and the normal (e.g., z-axis) to the boundary planes 150, 160.

According to an exemplary embodiment, the pretilt angles 01, 02 on the first and second substrates 130, 140 are in the range of 2 degrees to 15 degrees.

### Structural Twist Angle and Rotational Sense

A structural twist angle F of the LC structure is the difference between the azimuthal direction of the LC director 212 at the first alignment coating 170 (along x-axis at z=d) and the azimuthal direction of the LC director 216 at the second alignment coating 180 (along negative y-axis at z=0).

As described above, the structural twist angle F is defined by the structure of the display device 100 design. In particular, a structural rotation sense 220 (e.g., twist sense) for the LC mixture 120 in the display device 100 may be attributed to, for example, the manipulation of the azimuthal directions (x-axis and y-axis) of the surface-contacting LC directors/molecules 212, 216 by the design of the alignment coatings 170, 180 on the first and second substrates 130, 140 (e.g., as performed in U.S. Pat. Nos. 8,724,059 and 9,551,901, which are hereby incorporated by reference).

In the exemplary embodiment of FIG. 2, the structural rotational twist sense 220 is right-handed and the structural twist angle F is 90°. In embodiments of the present invention, the structural twist angle F is in the range of 75 degrees to 130 degrees.

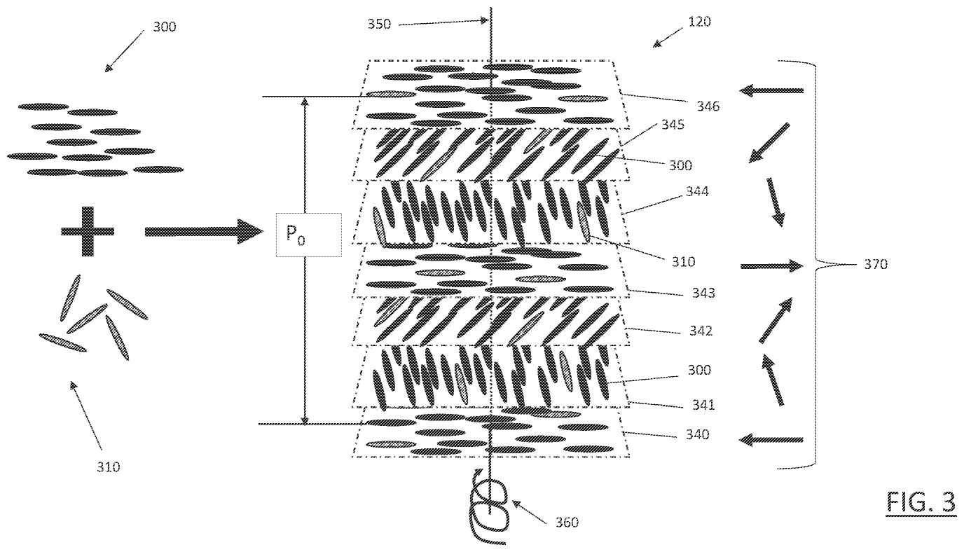

### FIG. 3 LC Mixture

Referring to FIG. 3, the LC mixture 120 is described in further detail. The LC mixture 120 includes a chiral material 310 dissolved in an LC material 300. In particular, molecules of the LC mixture 120 are schematically illustrated in a state where the LC mixture 120 is independent from the display device 100 and not subject to the alignment coatings 170, 180 (e.g., in ajar).

The LC mixture 120 may be referred to as a chiral nematic liquid crystal. The chiral nematic liquid crystal molecules organize in imagined planes 340, 341, 342, 343, 344, 345, 346 with no positional ordering within the imagined planes 340, 341, 342, 343, 344, 345, 346, but with a director axis 370 which rotates from one imagined plane 340, 341, 342, 343, 344, 345, 346 to the next. In FIG. 3, molecules of the LC material 300 and molecules of the chiral material 310 are shown in imagined planes 340, 341, 342, 343, 344, 345, 346 that are perpendicular to the chiral axis 350.

In accordance with an embodiment of the present invention, the LC material 300, for example, a nematic LC substance, would typically have all the molecules of the LC material 300 align in a loose parallel arrangement. However, when the chiral material 310 is added to the LC material 300, the molecules of the LC material 300 enter a chiral nematic phase in which the molecules of the LC material 300 are arranged in parallel, imagined planes 340, 341, 342, 343, 344, 345, 346 with adjacent imagined planes 340, 341, 342, 343, 344, 345, 346 slightly rotated according to an intrinsic rotational sense 360 of the LC mixture 120. Referring to FIG. 3, the intrinsic rotational sense 360 of the LC mixture 120 is left-handed and is illustrated as the molecules of LC material 300 and molecules of chiral material 310 change direction (i.e. rotate) moving from one imagined plane 340, 341, 342, 343, 344, 345, 346 to the next along the chiral axis 350.

### Intrinsic Rotational Sense

The chiral material 310 has an intrinsic (i.e., built-in) twist and introduces twist (intrinsic rotational sense 360 or a particular orientation, for example, right-handed or left-handed orientation) to the LC mixture 120 when, as shown in FIG. 3, the LC mixture 120 is not acted upon by outside alignment forces of the display device 100.

The chiral material 310 determines the handedness (i.e., chirality) of the LC mixture 120. The chirality induces a finite azimuthal twist 360 from one imagined plane 340, 341, 342, 343, 344, 345, 346 to the next, producing a helical twisting of the molecular axis along the layer normal. The intrinsic rotational sense 360 of the LC mixture 120 is the direction of twist of the molecules of LC material 300 and molecules of chiral material 310 along the chiral axis 350.

The chiral material 310 determines an intrinsic pitch Po and the intrinsic rotational sense 360 of the LC mixture 120. Adding the chiral material 310 to the LC material 300 results in the LC mixture 120 having an intrinsic pitch Po associated with the intrinsic rotational sense 360 of the LC mixture 120.

### Intrinsic Pitch Po

In particular, the molecules of the LC material 300 and the molecules of the chiral material 310 organize in imagined planes 340, 341, 342, 343, 344, 345, 346 with no positional ordering within the imagined planes 340, 341, 342, 343, 344, 345, 346, but align with a director axis 370 which varies from one imagined plane 340, 341, 342, 343, 344, 345, 346 to the next. For example, the director axis 370 of the molecules in each imagined plane 340, 341, 342, 343, 344, 345, 346 is perpendicular to the chiral axis 350. The variation of the director axis 370 moving along the chiral axis 350 tends to be periodic in nature. The period of this variation (the distance over which a full rotation of 360° is completed) is known as the pitch Po. In FIG. 3, the pitch Po is referred to as an intrinsic pitch Po of the LC mixture 120 because the LC mixture 120 is free from any aligning influence of the alignment coatings 170, 180 of the display device 100.

The industry standard method to define the concentration of the chiral material 310 is to indicate the value of the intrinsic pitch Po of the LC mixture 120. The intrinsic pitch Po (one pitch length) is the distance along the helical axis (e.g., chiral axis 350) for a complete 360-degree rotation of the molecules of the LC material 300 and the molecules of the chiral material 310 as shown in FIG. 3.

The helical pitch Po is a function of the helical twisting power (HTP) of the chiral material 310 and the concentration (C) of the chiral material 310 in the LC mixture 120. The intrinsic pitch Po can be calculated as Po=[HTP-C]¹, where helical twisting power (HTP) is in units of pm¹ and concentration (C) is in wt. %. The higher the concentration (C) and helical twisting power (HTP), the shorter the intrinsic pitch Po.

Based on this relation, it is possible to prepare LC mixtures 120 with different pitch values Po. In addition, the rotational sense 360 of the LC mixture 120 can be determined by selection of the chiral material 310. Intrinsic pitch Po is positive for a right-handed intrinsic rotational sense 360 and negative for a left-handed intrinsic rotational sense 360. For the example in FIG. 3, the intrinsic rotational sense 360 is left-handed.

### LC Mixture Chiral Material Selection

The LC mixture 120, in accordance with the present invention, includes at least one type of a LC material 300 and at least one type of a chiral material 310. For example, the LC mixture 120 may include an LC material 300 that includes or has been combined or mixed with other LC materials or substances.

### Rotational Sense

In an embodiment of the present invention, the structural rotational sense 220 of LC mixture 120 is at least partially attributed to the alignment coatings 170, 180. The display device 100 causes the LC mixture 120 to twist or rotate in a right-handed or left-handed manner when the LC mixture 120 is placed in the display 100. However, for clarity, the display derived rotational sense 220 is described with the LC material 300 in the display device 100.

The LC display device 100 is designed such that it causes the LC material 300 or substance to twist or rotate in a right-handed or left handed manner, according to the display derived rotational sense 220, when the LC material 300 or substance is placed in the display device 100 (i.e., display derived rotational sense), via, for example, the alignment coatings 170, 180 on each of the substrates 130, 140 of the display device 100.

The chiral material 310 is chosen such that the LC mixture 120, independent of the display device 100, has an intrinsic rotational sense 360 that is opposite of the display derived rotational sense 220.

Chiral materials 310 induce either a left-handed or right-handed to the LC material 300, such that the resulting LC mixture 120 has an intrinsic rotational sense 360 due to the addition of the chiral material 310. Merck KgaA, for example, provides chiral materials S-81 1, R-81 1, S-101 1 and R-101 1, where the S- and R-prefixes indicate, respectively, left handed and right-handed helical twisting powers. In an embodiment of the present invention, at least one of Merck KgaA, chiral materials S-81 1, R-81 1, S-101 1 and R-101 1 is utilized.

However, it should be understood by one of ordinary skill in the art that other chiral materials or mixtures of chiral materials may be utilized.

When the LC mixture 120 (i.e., an LC mixture that includes at least an LC substance or LC material 300 and a chiral material 310 or substance) is used in the LC display device 100, the forces imposed on the LC mixture 120 by, for example, the alignment coatings 170, 180 in the LC display device 100 induce the structural rotational sense 220 on the LC mixture 120 that overcomes, changes, or alters and is opposite the intrinsic rotational sense 360 of the LC mixture 120 when outside the display device 100.

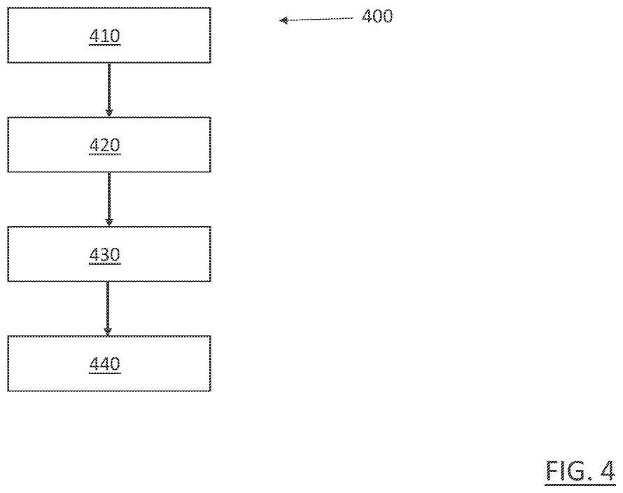

### FIG. 4 Method

According to a first step 410 of an exemplary method 400, the structural rotational twist angle F and sense 220 of the display device 100 is determined by the pretilt angles θ1, 02 and azimuthal directions of the alignment coatings 170, 180. According to a second step 420 of the exemplary method 400, a chiral material 310 with an opposite intrinsic rotational sense 360 is added to the LC material 300 to form the LC mixture 120.

For example, if the structural rotational sense 220 of the LC material 300 in the display device 100 is right-handed, then, in an embodiment of the present invention, a left-handed chiral material 310 (e.g., an S-labeled chiral material) is added to the LC material 300 to form the LC mixture 120.

In another example, if the structural rotational sense 220 of the LC material 300 in the display device 100 is left-handed, then, in an embodiment of the present invention, a right-handed chiral material 310 (e.g., an R-labeled chiral material) is added to the LC material 300 to form the LC mixture 120.

Once the handedness of the chiral material 310 to be added to the LC material 300 is determined, according to a third step 430 of the method 400, a chiral material 310 can be selected from a group of chiral materials 310 having that handedness.

Intrinsic Pitch Po and d/Po ratio

Once the chiral material 310 is selected, according to a fourth step 440 of the exemplary method 400, the concentration (C) of the chiral material 310 can be determined from its helical twisting power HTP based on a desired intrinsic pitch Po of the LC mixture 120, and more specifically based on a desired d/Po ratio.

The d/Po ratio is the ratio of the thickness (d) of the LC mixture 120 when it is in the display device 100 (i.e., the cell gap or cell spacing of the display device 100) to the intrinsic pitch Po of the LC mixture 120. As such, the d/Po ratio represents both the thickness (d) of the LC mixture 120 in the display device 100 or cell gap of the display device 100 and the intrinsic pitch (Po) of the LC mixture 120.

Generally, one or both of the thickness (d) and the intrinsic pitch (Po) can be selected to achieve a desired d/Po ratio. According to the exemplary method 400, for a given thickness d in the display device 100, the concentration (C) of the chiral material 310 can be selected to provide the LC mixture 120 with an intrinsic pitch Po that falls within a desired range of d/Po ratios. In particular, knowing the helical twisting power (HTP) of the selected chiral material 310, the concentration (C) of a chiral material 310 can be determined according to C=(d/Po) [d−HTP]¹ to achieve a desired d/Po ratio. As discussed in further detail below, a desired d/Po ratio include d/Po ratios in a range of −0.2 to −0.4 where the negative value represents that the intrinsic rotational sense 360 of the LC mixture 120 outside the display device 100 is opposite the structural rotational sense 220 of the LC mixture 120 inside the display device 100.

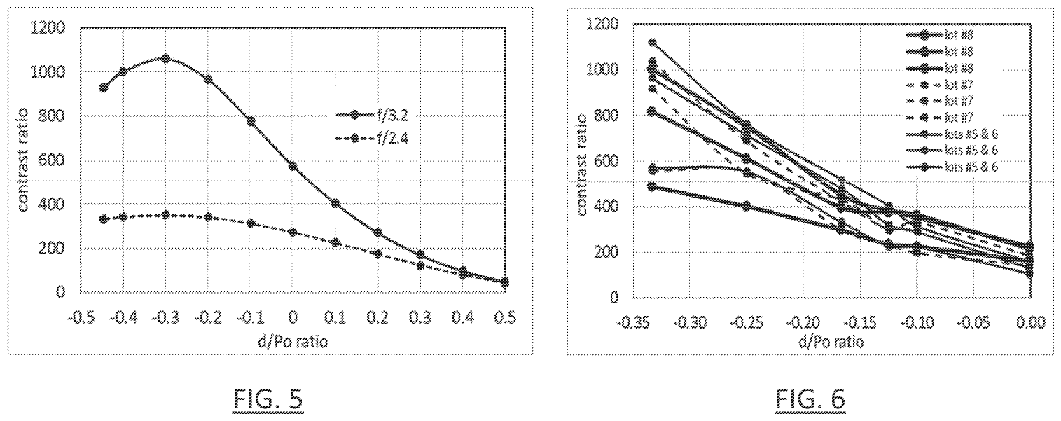

FIGS. 5-9 Effect of d/Po Ratio on Contrast Ratio, Tilt Angie, and Throughput

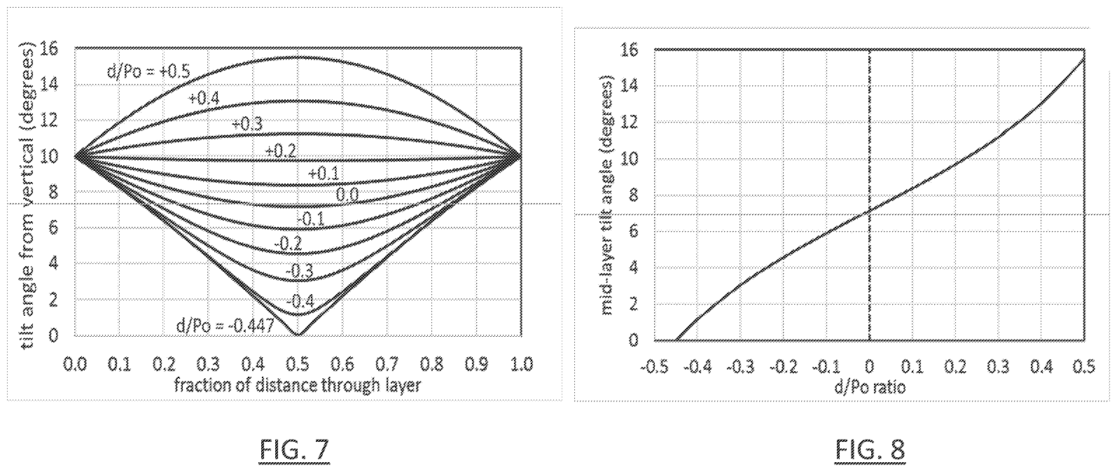

As described below with respect to FIGS. 5-6, at a desired d/Po ratio, the contrast ratio of the display device 100 is improved. In particular, as described below with respect to FIGS. 7-8 and the LC director field 210 of FIG. 2, the LC tilt angle Q of the LC directors 214 in the bulk of a layer of the LC mixture 120, is substantially decreased while the pretilt angles 01, 02 of the surface-contacting directors 212, 216 is kept high. The low tilt angle 0 of the LC directors 214 in the bulk of a layer of the LC mixture 120 provides higher contrast ratios, while at the same time the high pretilt angles 01, 02 of the surface-contacting directors 212, 216 at the alignment coatings 170, 180 suppress the inter-pixel defects and misalignments.

### FIGS. 5-9 Graphical Representation of LC Mixture in the Display

FIGS. 5-9 represent performance measures, including contrast ratio, tilt angle, and throughput, of various display devices 100 incorporating various LC mixtures 120, including those discussed above, and thereby resulting in various d/Po ratios.

In FIGS. 5-9, positive d/Po ratio values represent that a rotational twist sense of a LC mixture in a display device and an intrinsic twist sense of a LC mixture (with chiral) have the same handedness or sense. Notably, positive d/Po values are not used according to the method 400 described above because of the same handedness. However, these d/Po ratios are provided to illustrate the improved contrast ratios for the opposite handedness.

Negative d/Po ratio values correspond to the case of contrary handedness, in accordance with the present invention. In other words, where the intrinsic rotational sense 360 of the LC mixture 120 is opposite to the structural rotational sense 220 when the LC mixture 120 is subjected to the forces or elements (for example, the alignment coatings 170, 180) of the LC display device 100.

FIGS. 5 and 6: Contrast Ratio Vs. d/Po Ratio

Generally, a desired d/Po ratio is that which substantially increases a contrast ratio of the display device 100. FIG. 5 is a graph showing simulations of contrast ratio vs. d/Po ratio of an LCoS display (e.g., LC display device 100). Two curves are shown in FIG. 5. One curve is for an optical design, for example, a projection optical design, in accordance with the present invention, operating with f/3.2 optics and the other is for an optical design, for example, a projection optical design, in accordance with the present invention, operating with f/2.4 optics.

In FIG. 5, it is clear that the contrast ratio is greater for negative d/Po ratios, particularly around values of −0.3. As the d/Po ratio increases from zero to +0.5, the contrast ratio decreases.

Also, d/Po ratios less than −0.447 are undesirable, as at this point the intrinsic twist sense 360 of the LC mixture 120 overcomes the 90-degree structural twist F and the display device 100 transitions to a 270-degree structural twist F with the wrong structural twist sense (i.e., one that is opposite the structural twist sense 220 and thus the same structural twist sense as the intrinsic twist sense 360 of the LC mixture 120).

Similarly, FIG. 6 is a graph showing measurements of contrast ratio vs. d/Po ratio for a series of different displays (coming from four different manufacturing lots). In these experiments, a series of structurally right-handed display cells 100 from the different lots were filled with LC mixtures 120 including varying amounts of left-handed chiral material 310. As a result, the display devices 100 cover a range of negative d/Po ratios.

As can be seen in FIG. 6, the contrast ratio of a display device 100 can be increased (e.g., by two to almost six times) by adding a left-handed chiral material 310. However, if the d/Po ratio becomes much more negative than about −0.33, for example, a transition to the wrong structural twist sense begins to take place and defects begin to arise.

In an embodiment of the present invention with 90 degree structural twist, a value of the d/Po ratio is in a range of −0.10 and −0.33 results in higher contrast ratios. For example, FIGS. 5-9 represent 90 degree twist angles.

In other embodiments, the structural twist angle is in a range of 75 degrees to 130 degrees or in a range of is in a range of 82 degrees to 98 degrees. For smaller structural twist angles the preferred d/Po ratio would be proportionally smaller and for larger structural twist angles the preferred d/Po ratio would be proportionally larger. For example, for 75 degrees, a value of the d/Po ratio is in a range of −0.27 to −0.08; and, for 130 degrees, a value of the d/Po ratio is in a range of −0.48 to −0.14.

FIGS. 1 and 8: Tilt Angle Through the LC Layer for d/Po

As mentioned above, the LC tilt angle Q of the LC directors 214 in the bulk of a layer of the LC mixture 120 is substantially decreased while the pretilt angles Q1, Q2 of the surface-contacting directors 212, 216 are kept high.

For example, the surface contacting directors 212, 216 have pretilt angles Q1, Q2 of greater than or equal to 2 degrees at the alignment coatings 170, 180. Higher pretilt angles 01, 02 at the alignment coatings 170, 180 reduce inter-pixel defects and misalignments at pixel boundaries.

For example, the LC directors 214 have tilt angles Q in a range of 1 to 8 degrees in the bulk of the LC mixture 120.

FIG. 7 is a simulation showing a tilt angle Q profile (e.g., of the directors 212, 214, 216) through the LC director field 210 (here, the x-axis values are the fraction of the distance through the thickness d of the LC mixture 120) for various values of the d/Po ratio when no voltage is applied to the display device 100. Here, it can be seen how the tilt angle Q changes through the thickness d of the LC mixture 120 depending on the d/Po ratio and how, for the same d/Po ratio, lower tilt angles Q in the LC mixture 120 correspond to the higher contrast ratios described above.

Continuing with FIG. 7, the pretilt angles 01, 02 of the surface contacting directors 212, 216 at the two alignment coatings 170, 180 (indicated by fractional values of 0.0 and 1.0 on the x-axis) are fixed at 10 degrees and are independent of the d/Po ratio. Depending upon the value of the d/Po ratio, the tilt angle 0 either increases or decreases from the 10-degree boundary pretilt angle 0 value to a maximum or minimum value in the middle of the LC director field 210 (0.5 on the x-axis).

Again, positive d/Po values are not used according to the method 400 described above because of the same handedness. However, these d/Po ratios are provided to illustrate the lower tilt angles Q for the opposite handedness.

Without the addition of any chiral material 310 (i.e., d/Po=0), the case for the TVAN mode, as described in U.S. Pat. Nos. 8,724,059 and 9,551,901, and such patents are hereby incorporated by reference, the mid-layer director 214 tilt angle Q is about 7.15 degrees, which is 2.85 degrees less than the 10-degree value at the alignment coatings 170, 180. The smaller mid-layer director 214 tilt angle Q of the TVAN mode results in a smaller overall residual retardation with less dark state light leakage and a higher contrast ratio than the VAN mode. Residual retardation is that retardation that arises because the surface-contacting director is not perfectly perpendicular to the alignment coating, but makes a small pretilt angle.

As is seen in FIG. 7, reducing the d/Po ratio below zero results in an even lower mid-layer director 214 tilt angle Q with even less residual retardation for an even higher contrast ratio. Finally, the mid-layer director 214 tilt angle Q becomes zero for d/Po=−0.447. Reducing the d/Po ratio below −0.447 results in a transition to a structural twist angle with the wrong structural twist sense.

Increasing the d/Po ratio above zero increases the mid-layer director 214 tilt angle Q, and for d/Po values of 0.3, 0.4, and 0.5 the mid-layer director 214 tilt angle Q is actually larger than the pretilt angle Q at the boundary 130, 140. This increases the residual retardation and accompanying light leakage and reduces the contrast ratio.

The response of the tilt angle Q to changes in the d/Po ratio qualitatively explains the contrast ratio vs. d/Po ratio behavior shown in FIGS. 4 and 5. The lower tilt angles Q result in higher contrast ratios.

FIG. 8 shows the dependence of the mid-layer director 214 tilt angle Q on the d/Po ratio when no voltage is applied to the display device 100. Here, a mid-layer director 214 tilt angle Q in a range of approximately 1 to 4.5 degrees may be achieved by using d/Po ratio in a range of approximately −0.4 to −0.2. Again, positive d/Po values are not used according to the method 400 described above because of the same handedness. However, these d/Po ratios are provided to illustrate the lower tilt angles Q for the opposite handedness.

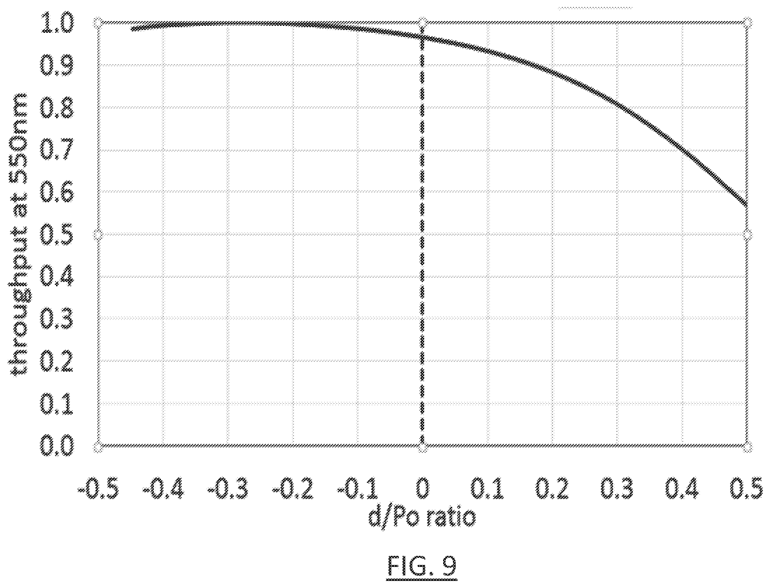

FIG. 9: Effect of d/Po on Throughout

FIG. 9 shows the dependence of the throughput or polarization conversion efficiency on the d/Po ratio when a voltage is applied to the display device 100. An LCoS throughput approaching 100 percent may be achieved by using d/Po ratio in a range between and including −0.4 and −0.2. Again, positive d/Po values are not used according to the method 400 described above because of the same handedness. However, these d/Po ratios are provided to illustrate the higher throughput for the opposite handedness.

### CONCLUSION

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
a first substrate having a first alignment coating;
a second substrate having a second alignment coating; and
a liquid crystal mixture positioned between and having a thickness defined by a distance between the first alignment coating and the second alignment coating, wherein the liquid crystal mixture comprises:
a liquid crystal material; and
a chiral material;
wherein the first alignment coating and the second alignment coating are configured to cause the liquid crystal mixture to adopt a first twisted configuration, wherein the first twisted configuration has structural twist angle and a structural rotational sense; and
wherein the chiral material has a helical twisting power and the liquid crystal mixture has a concentration of the chiral material such that the liquid crystal mixture has an intrinsic rotational sense, independent of the first alignment coating and the second alignment coating, that is opposite to the structural rotational sense.

2. The device of claim 1, wherein the concentration and helical twisting power of the chiral material determine an intrinsic pitch of the liquid crystal mixture; and
wherein a value of the thickness divided by the intrinsic pitch is in a range of −0.1 and −0.45.

3. The device of claim 1, wherein the first twisted configuration includes a first surface director at the first alignment coating, a second surface director at the second alignment coating, and a plurality of middle directors including a mid-layer director between the first surface director and the second surface director;
wherein the first surface director includes a first pretilt angle and a first azimuthal direction, and the second surface director includes a second pretilt angle and a second azimuthal direction; and
wherein the structural twist angle is an angle between the first azimuthal direction and the second azimuthal direction.

4. The device of claim 3, wherein the structural twist angle is in a range of 75 degrees to 130 degrees.

5. The device of claim 3, wherein the structural twist angle is in a range of 82 degrees to 98 degrees.

6. The device of claim 5, wherein the structural twist angle is 90 degrees.

7. The device of claim 3, wherein each of the first pretilt angle and the second pretilt angle is in a range of 2 degrees to 15 degrees.

8. The device of claim 3, wherein each of the first pretilt angle and the second pretilt angle is in a range of 8 degrees to 12 degrees.

9. The device of claim 3, wherein a tilt angle of the mid-layer director is in a range of 1 degree to 5 degrees.

10. The device of claim 3, wherein each of the plurality of middle directors are in a range of 1 to 8 degrees.

11. The device of claim 2, wherein the value of the thickness divided by the intrinsic pitch is in a range of −0.2 and −0.4.

12. The device of claim 1, comprising a plurality of pixel elements each having a pixel pitch of less than or equal to 4.0 pm.

13. The device of claim 1, wherein the thickness is less than or equal to 2.0 pm.

14. The device of claim 1, wherein a throughput is greater than 99 percent.

15. A method, comprising:
determining a structural rotational sense of a liquid crystal mixture in a liquid crystal display device, the liquid crystal display device having:
a first substrate having a first alignment coating;
a second substrate having a second alignment coating; and the liquid crystal mixture positioned between and having a thickness defined by a distance between the first alignment coating and the second alignment coating;
selecting a chiral material with a rotational sense that is opposite the structural rotational sense, the chiral material having a helical twisting power;
determining the thickness of the liquid crystal mixture;
determining a value of the thickness divided by an intrinsic pitch of a liquid crystal mixture including a liquid crystal material and the chiral material, wherein the value is in a range of −0.1 and −0.4;
determining an intrinsic pitch according to the thickness and the value;
determining a concentration of the chiral material according to the intrinsic pitch and the helical twisting power; and
mixing the chiral material with the liquid crystal material to form the liquid crystal mixture with the determined concentration of chiral material.

16. The method of claim 15, wherein the first alignment coating and the second alignment coating are configured to cause the liquid crystal mixture to adopt a first twisted configuration, wherein the first twisted configuration has a structural twist angle and the structural rotational sense.

17. The method of claim 16, wherein the first twisted configuration includes a first surface director at the first alignment coating, a second surface director at the second alignment coating, and a plurality of middle directors including a mid-layer director between the first surface director and the second surface director;
wherein the first surface director includes a first pretilt angle and a first azimuthal direction, and the second surface director includes a second pretilt angle and a second azimuthal direction; and
wherein the structural twist angle is an angle between the first azimuthal direction and the second azimuthal direction.

18. The method of claim 17, wherein the structural twist angle is in a range of 75 degrees to 130 degrees;
wherein each of the first pretilt angle and the second pretilt angle is in a range of 2 degrees to 15 degrees;
wherein a tilt angle of the mid-layer director is in a range of 1 degree to 5 degrees; and
wherein each of the plurality of middle directors are in a range of 1 to 8 degrees.

19. A liquid crystal mixture for placement in a display, comprising:
a liquid crystal material; and
a chiral material; and
wherein the liquid crystal material has an intrinsic rotational sense that is opposite in direction to the structural rotational sense imposed on the liquid crystal mixture by the display.

20. The liquid crystal mixture of claim 19, wherein the liquid crystal mixture is configured to adopt a first twisted configuration under an influence of a first alignment coating and a second alignment coating of a display, wherein the first twisted configuration has a structural twist angle and the structural rotational sense; and
wherein the chiral material has a helical twisting power and the liquid crystal mixture has a concentration of the chiral material such that the liquid crystal mixture has the intrinsic rotational sense, independent of the first alignment coating and the second alignment coating, that is opposite to the structural rotational sense.
